(19) United States
(12) Patent Application Publication
(10) Pub. No.: US 2019/0100331 A1
(43) Pub. Date: Apr. 4, 2019

(54) UNMANNED AERIAL VEHICLE (UAV) RECHARGING/REFUELLING STATION

(71) Applicant: Colin WRIGHT, Ottawa (CA)

(72) Inventor: Colin WRIGHT, Ottawa (CA)

(21) Appl. No.: 16/140,927

(22) Filed: Sep. 25, 2018

(30) Foreign Application Priority Data
Sep. 29, 2017 (CA) 2980904

(51) Int. Cl. B64F 1/02; B64F 1/20; B64F 1/36; B64F 1/28

(52) U.S. Cl. CPC B64F 1/02; B64F 1/20; B64C 39/024; B64F 1/28; B64F 1/362

(57) ABSTRACT

A recharging/refuelling station for an unmanned aerial vehicle (UAV) and a network of the same are provided. Optionally the recharging/refuelling stations are network with a central control. Individual recharging/refuelling stations include a landing platform that includes a UAV capture system and a recharging or refuelling system. The recharging/refuelling stations may be equipped with a variety of sensors or modules to facilitate UAV landing and recharging/refuelling.

### FIELD OF THE INVENTION

The present invention pertains to the field of unmanned aerial vehicle (UAV) recharging/refuelling stations and, more particularly to UAV recharging/refuelling stations in remote locations or locations of limited accessibility.

### BACKGROUND OF THE INVENTION

Compact unmanned aerial vehicles (UAVs), commonly called drones, can be used in a wide range of commercial, scientific, agricultural and government applications such as those requiring surveillance and monitoring. For example, UAVs are useful for monitoring the perimeters of large facilities such as power plants or components therein that are not readily accessible, for inspecting power transmission lines and pipelines, watching remote border crossing points, wildlife population counts for herd health calculations and species at risk including those both on land and water, large agricultural area surveillance and monitoring of natural events such as forest fires, volcanoes or glacier melt rates.

UAVs may be piloted remotely or controlled by on-board computer systems. Housed within the UAV's body are various components including the power supply and platform, computer and communication systems, sensors and actuators and potentially video and camera equipment.

UAVs include both rotorcrafts such as mono-, bi- and quadcopters and fixed-winged crafts.

UAVs may be electrically powered or fuel powered. The range of small UAVs is limited by their fuel or battery capacity. Most available small commercial UAVs have a maximum flying time of less than an hour which includes the time to fly to the target area and return before refuelling or recharging. This limits their effective useful range to less than 10 km (6 miles) without refuelling or recharging.

To effectively increase the useful range of small commercial UAVs, recharging and refuelling stations may be used. UAV charging stations are known in the art and include those described in EP 3 081 486 and U.S. Pat. No. 9,527,605. Such charging stations are generally more appropriate for urban, serviced or accessible areas, and are only effective in ideal weather conditions with minimal winds to affect landing and station keeping while being recharged.

Other power stations including those by Blue Vigil require that the UAV remain tethered to the power station throughout its flight. This provides operators with an elevated view above their current location but does not allow the UAV to move to provide views of more distant objects.

The range of UAVs is also impacted by the line-of-sight range of the radio controllers for the majority of UAVs. Typically, such controllers are no longer viable at distances beyond 2 km (1.2 miles), this is especially true for WIFI connections with real-time video feeds from onboard cameras.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an unmanned aerial vehicle (UAV) recharging/refuelling station. In accordance with an aspect of the present invention, there is provided a recharging/refuelling station for an unmanned aerial vehicle (UAV) comprising a landing platform comprising a UAV capture system and a recharging or refuelling system.

In accordance with another aspect of the invention, there is provided a recharging/refuelling network for unmanned aerial vehicles (UAVs) comprising two or more recharging/refuelling stations, wherein each station of the two or more stations is optionally in communication with at least one other station.

### BRIEF DESCRIPTION OF THE FIGURES

These and other features of the invention will become more apparent in the following detailed description in which reference is made to the appended drawings.

FIG. 1 provides a schematic of various components of the UAV station of an embodiment of the present invention for vertical take-off and landing (VTOL) type UAV. Landing Platform (100); Tether Arresting Slot (101); Landing Platform Tether Guides (102); Arresting Gear (103); Recharging/Refuelling Function (104); Communications Station (105); Station Power (106) with solar panel.

FIGS. 2A to 2D illustrate embodiments of the platform pivoting into the wind. FIG. 2A illustrates a top view of VTOL landing platform with weather rotation where Landing Platform Tether Guides (102) are configured to rotate the platform in response to wind around pivot point (201). FIG. 2B illustrates a top view of VTOL landing platform configured for electromechanical rotation around a pivot point (201) in response to a signal from a commercial wind vane (202). FIG. 2C illustrates a side view of a VTOL landing platform with weather vane rotation detailing the free rotation coupling (203) between the landing platform and support pole, and the rotating power couplings (204) for tether capture and recharging/refuelling systems. Also shown is the tether capture mechanism and recharge/refuel systems (205) fixed to platform below tether guide slot (shown with tether (207) in guide slot approaching capture point). FIG. 2D illustrates a side view of a VTOL landing platform with electromechanical rotation detailing the electromechanically driven rotation coupling (208) between the landing platform and support pole, and the rotating power couplings (204) for tether capture and recharging/refuelling systems. Also shown is the tether capture mechanism and recharge/refuel systems (205) fixed to platform below tether guide slot (shown with drone tether (207) in guide slot approaching capture point)

FIG. 3 illustrates a top view of a vertical take-off and landing (VTOL) platform detailing the tether guides (102) and arresting gear slot (101).

FIG. 4 illustrates a top view of a fixed-wing UAV landing platform detailing the tether guides (102) and arresting gear slot (101).

FIGS. 5A to 5C illustrates platform lighting as landing aids. FIG. 5A illustrates approach angle and orientation lighting. FIG. 5B illustrates a VTOL landing platform with perimeter (filled ovals) and centerline (open ovals) lighting. FIG. 5V illustrates a fixed-wing/hybrid landing platform with perimeter (filled ovals) and centerline (open ovals) lighting.

FIG. 6 illustrates a UAV tether detailing the tether weight (301) and recharge/refuel connectors (302).

FIG. 7 illustrates a fuel nozzle connector in one embodiment of the UAV tether where the tether includes both the fuel lines and tether cord.

FIG. 8 illustrates an electrical recharging UAV tether where the tether contains the positive and negative wiring as well as the tether cord. Also shown is a connector weather hood and both positive and negative connectors.

FIG. 9 illustrates a bottom view of an arresting gear below a VTOL landing platform detailing the arresting gear fork for tethers with knob ends, a spring loaded sensor switch configured to be pushed open by the tether moving into the capture position and the tether slot.

FIG. 10 illustrates a side view of an arresting gear below a VTOL landing platform with tether engaged in arresting gear fork angled to hold the tether. Also shown is the electric motor with gears that pulls the tether down into position

FIG. 11 illustrates tether placement and options. Panels A and B show tethers as installed detailing tether weight distance ‘A’ to the landing gear. Panels C to E show tether weight options including weighted sphere (C), weighted cylinder (D), weighted disk (E) and aircraft carrier style hook (F).

FIG. 12 illustrates a communication relay detailing a radio network on the charging poles supporting beyond line-of sight control of UAVs enabling the camera to continue to transmit live video feeds.

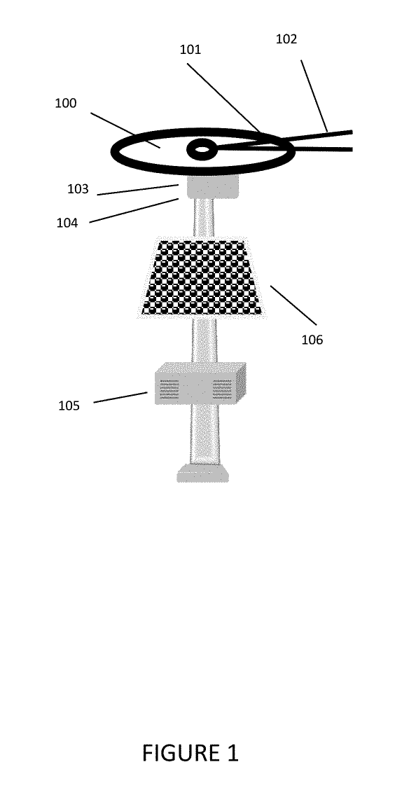

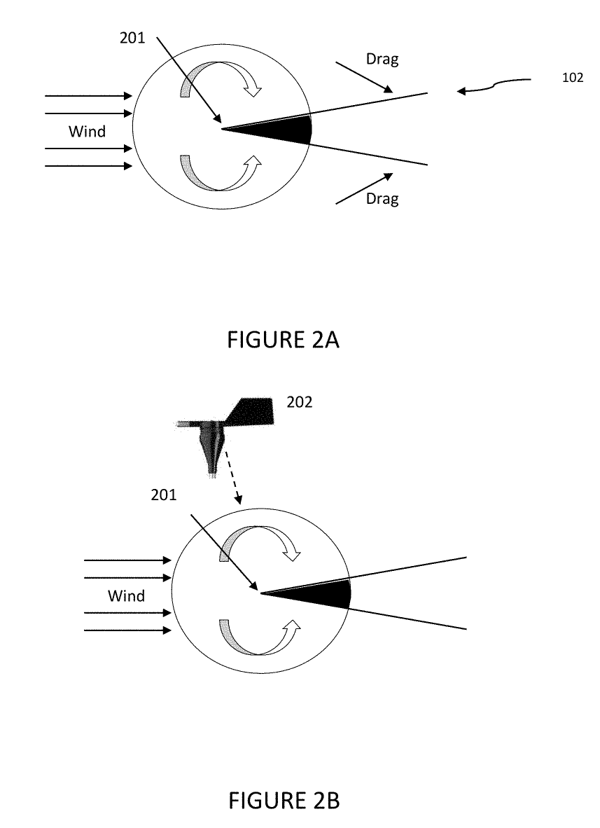

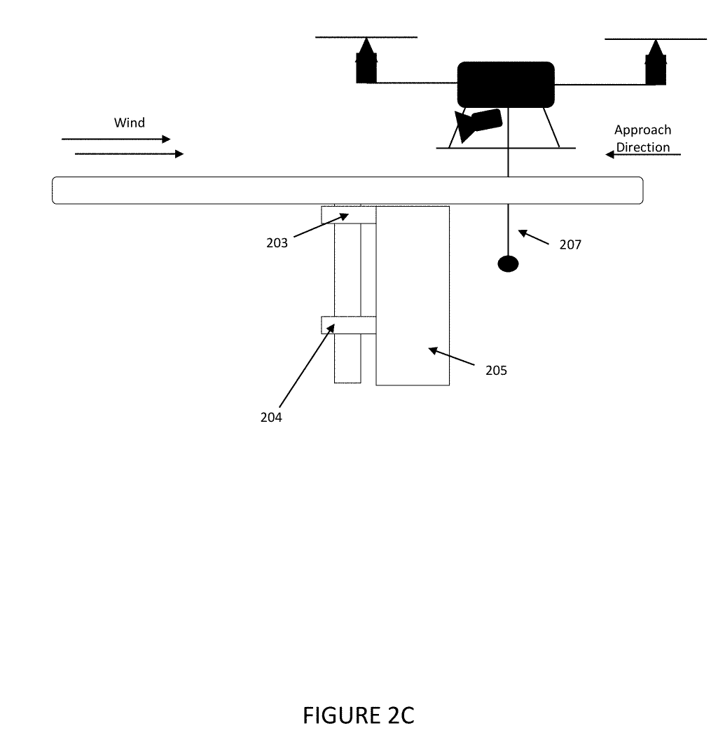

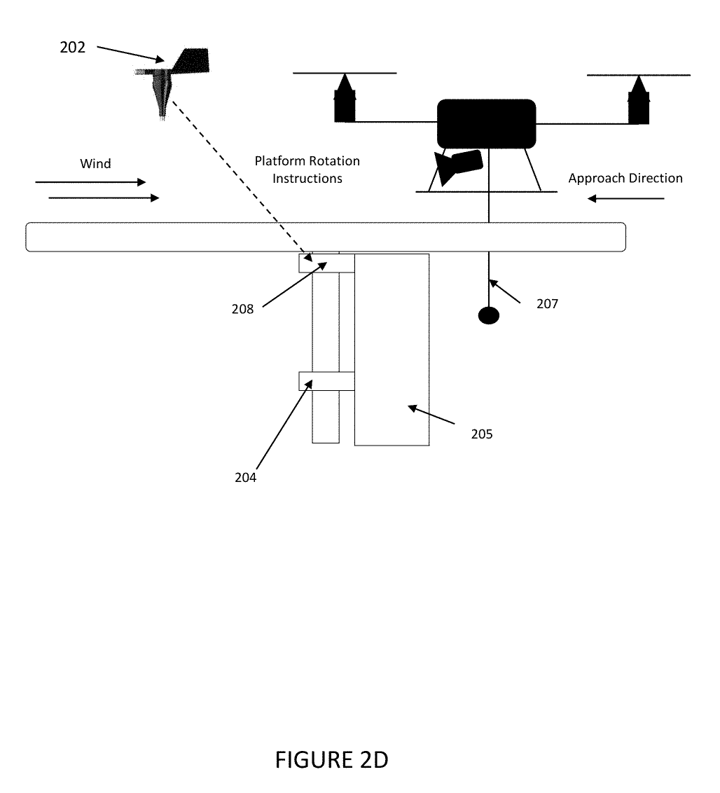

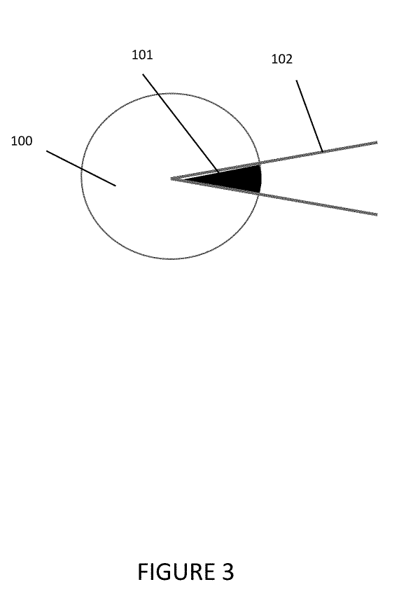

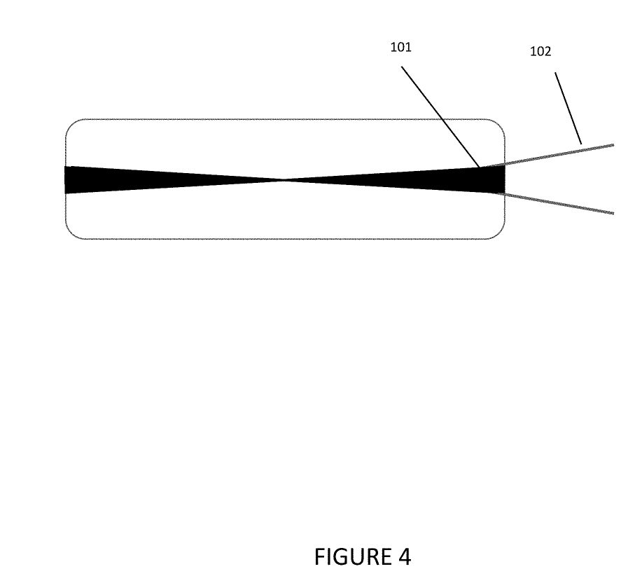

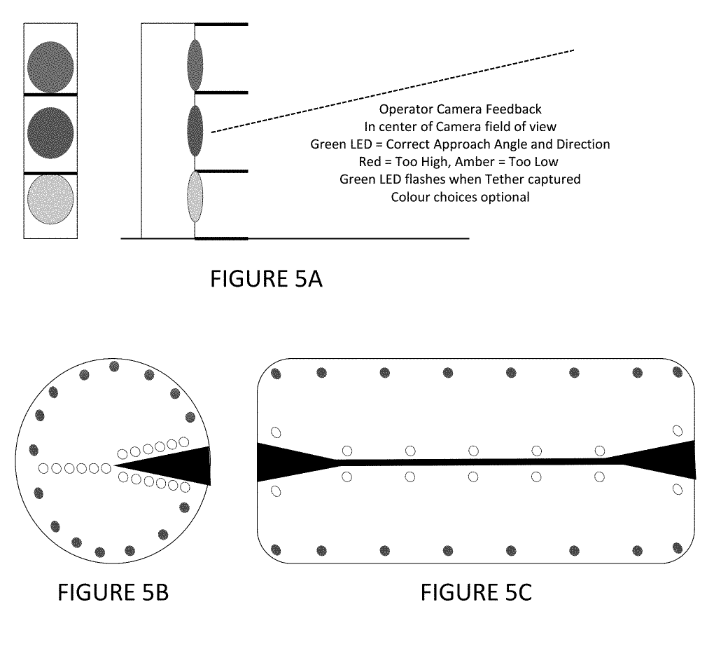

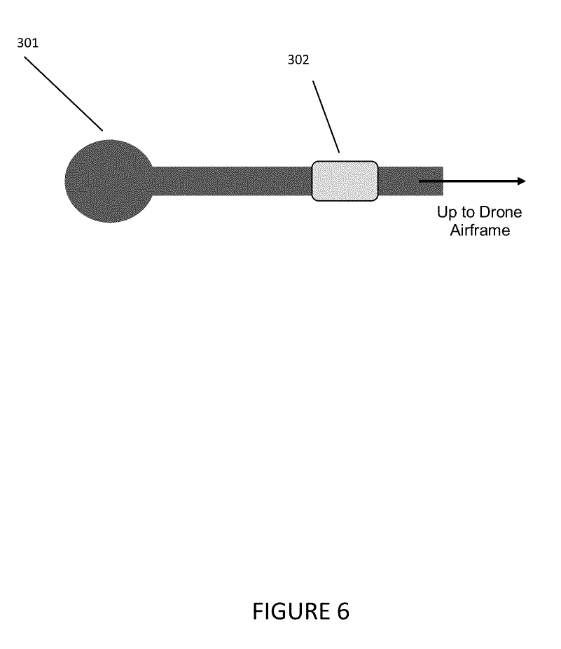

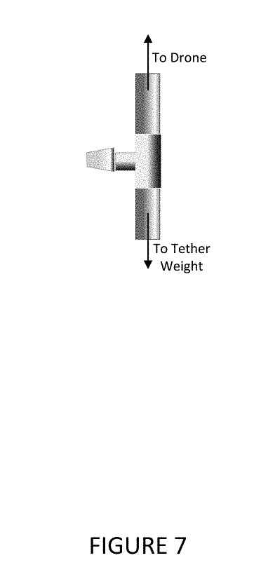

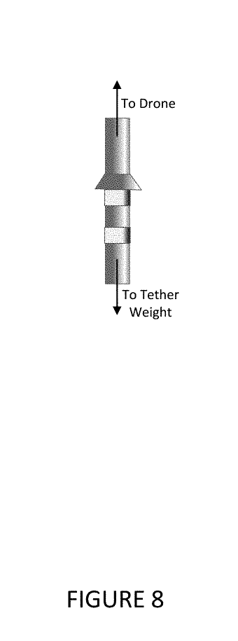

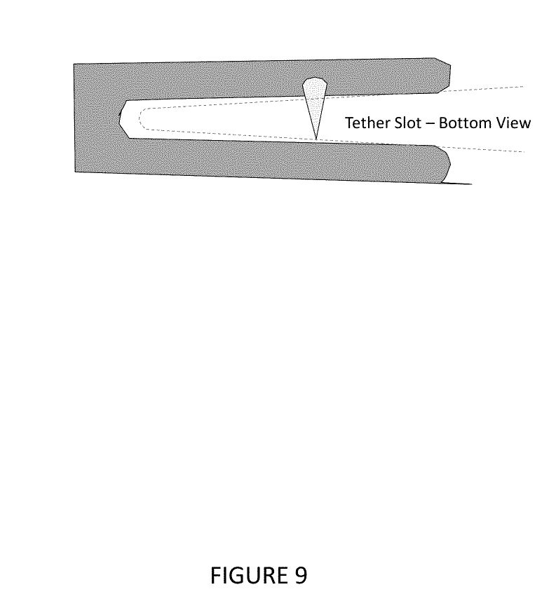

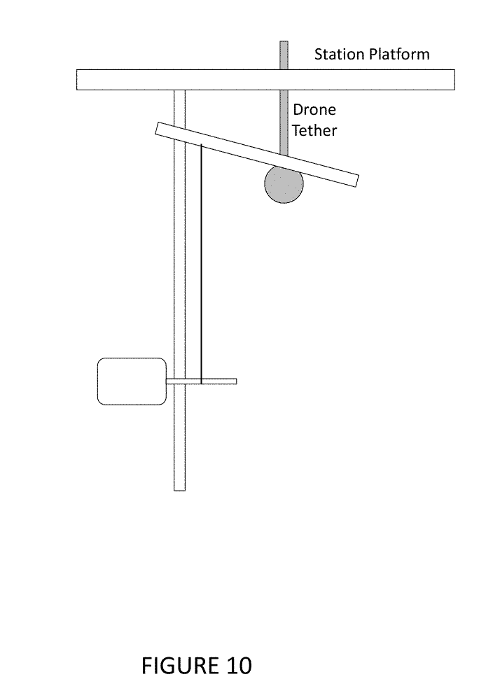

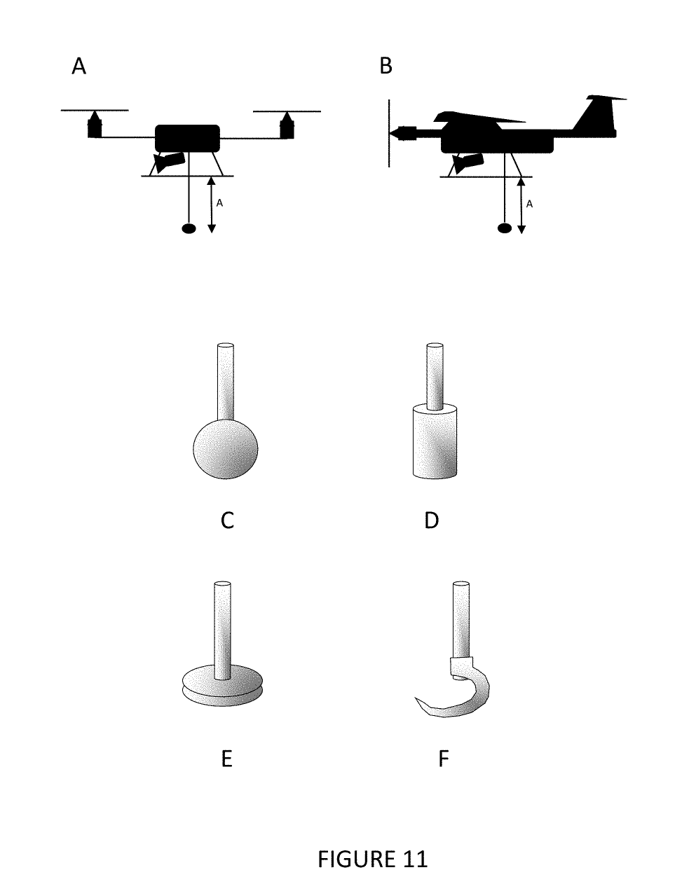

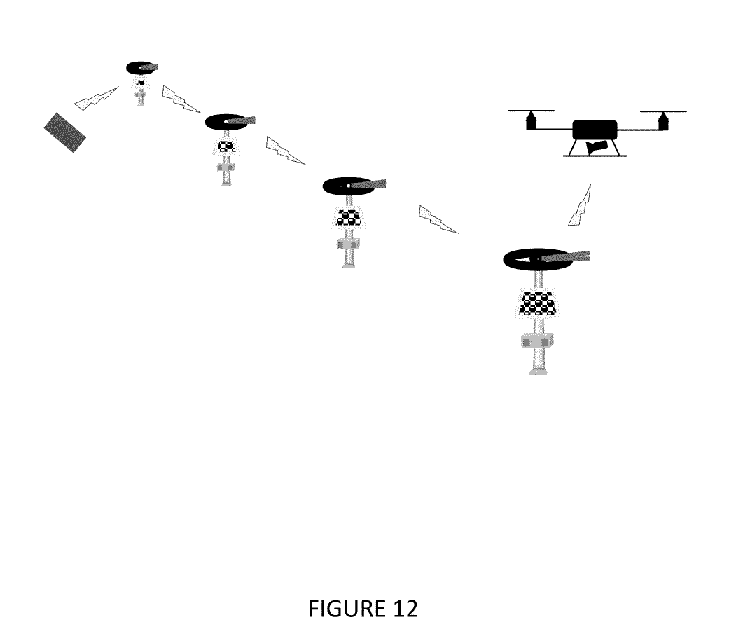

### DETAILED DESCRIPTION OF THE INVENTION

This invention provides a fully automated remote recharging/refuelling station for small UAVs. The stations can be used individually or as a network or series of recharging stations. A series or network of stations can be used to increase the effective range of the UAV. For example, a station every 10 km (6 miles) along a pipeline would allow a small commercial UAV to travel hundreds of kilometers during an inspection and even remain at a remote site if required, parked on one of the recharging platforms. Where more than one station is employed, the station may be controlled and monitored by a central operator.

Each station is configured to be fully autonomous to handle UAV arrivals, recharging/refuelling, and departures without the need for direct outside intervention. In some embodiments, the stations are configured to operate as a stand-alone unit.

As detailed in the figures and as described in detail below, the station components may include (100) Landing Platform; a UAV capture system including in some embodiments a Tether Arresting Slot (101), Landing Platform Tether Guides (102) and Arresting Gear (103); Recharging/Refuelling Function (104); Communications Station (105); Station Power (106). Optionally, the station may include one or more means to signal station availability and/or assist with landing.

Each Recharging/Refuelling Station is designed to operate in a variety of locations and environments for optimal flexibility. Forest fire monitoring may require these stations to be mobile, or easily re-locatable, as the forest fires spread or change direction. In those cases where mobility is required, the stations may be mounted on top of fire-fighting vehicles that are parked for landing and take-off, or on top of easily erected portable poles. In other instances such as oil spill or smuggling observation, the stations may be mounted on ships, small boats, or even floating offshore buoys.

In some embodiments the system could be used as part of an unmanned forward observation post for military or peacekeeping requirements, without any risk of danger to human observers. A series of small standard military observation drones such as a modified RQ-11B Raven, with added landing skids and autonomous recharging connections, could operate from a series of easily relocated recharging stations in a strategic location. These UAVs could take turns flying reconnaissance missions and transmitting their video material to base, before returning to their station for recharging.

Each station includes a landing platform to facilitate UAV landing. The landing platform is generally constructed of materials resistant to damage caused by prolonged exposure to environmental conditions such as, but not limited to, aluminum, carbon fibre, and ultra-violet protected rigid plastics. These platforms may be tilted in some embodiments to facilitate water run-off in rainy conditions. In some embodiments, the landing platform is elevated to reduce the risk of interference from surrounding objects, vegetation and geographic features. For those applications involving station installations in populated or otherwise at-risk (security) areas this elevation will also reduce the incidence of tampering, theft or vandalism.

The platform may be configured in a variety of shapes. In certain embodiments, the landing platform is a universal platform which is shaped to accommodate a variety of UAV types including but not limited to vertical take-off and landing (VTOL) UAVs, and fixed wing UAVs. In other embodiments, the landing platform is optimized for a particular UAV type. For example, for VTOL UAVs, while the landing platform could be any shape as long as it is of sufficient size to accommodate the UAV landing gear, or skids, the optimal shape for a VTOL landing platform is circular or rectangular, similar to a conventional helicopter landing pad, and for fixed-wing UAVs the platform may be shaped resemble a short runway (i.e. elongated rectangular shape). In certain embodiments, the landing platform is circular. In certain embodiments, the landing platform is rectangular.

A worker skilled in the art would appreciate that the platform size is dependent on the size and type of UAV. In particular, a worker skilled in the art, would appreciate that the size of the landing platform for UAVs which do not require a runway for take-off and landing could be any size so long as it can accommodate the UAV landing gear, or skids. In certain embodiments, the landing platform could have a cross section of about 1 m for current widely available commercial VTOL UAVs. In certain embodiments, for fixed-wing UAVs, the runway shaped platform would be at least 3 times the length of the UAV it is supporting, or at least 2.5 m for current widely available commercial fixed-wing UAVs. These sizes would change in accordance with the size and types of UAV drones the stations are intended to support. In certain embodiments where the fixed-wing UAVs being supported have higher Stall Speeds, the length of the platform would have to be increased to provide support for the landing gear until the UAV was able to reach take-off speed when leaving the station.

The landing platform may be fixed or may be movable. In certain embodiments, to facilitate landing and take-off, the landing platform can be moved in various directions, including forward, side to side, up or down and/or backwards. Optionally, the landing platform can be rotated or tilted. The movements may be in response to operator input (i.e. manual), or automatic in response to sensor input. For example, the landing platform may automatically turn in response to wind conditions such as wind direction. In a specific example, the landing platform could be rotated to facilitate landings or take-offs. In certain embodiments, motor-driven rotation based on input from a local anemometer (for wind speed) and weathervane (for wind direction) equipment is used to rotate the landing platform. In another embodiment, guide arms used to guide a UAV tether into a tether slot on the landing platform also function as a weather vane for the platform and rotate the platform in response to wind direction.

In certain embodiments, the station is for use with UAVs which have a tether. In such embodiments, the station is equipped with a UAV capture system which is configured to engage a tether of a UAV to either facilitate landing and/or secure a UAV to the landing platform and/or may also function in the establishment of a tight connection between the UAV Tether connectors and the Refuelling or Recharging connectors of the platform. The UAV capture system may be configured to engage with various types of tether designs including tethers with weighted spheres, weighted cylinders, weighted disks or aircraft carrier style “hooks”. The UAV capture system may comprise one or more types of arresting gear for the UAV tether such as a slot in the landing platform, or an arresting cable or wire such as those used on aircraft carriers, or capture means such as claws, clamps, rollers, electromagnetic restraints, or other similar electromechanical systems.

In certain embodiments, the landing platform may include a slot for a UAV tether to slide into for capture. The slot may be a variety of shapes including but not limited to V-Shaped, U-Shaped, Round, Oval or Rectangular. In certain embodiments, to facilitate alignment with the capture system, the slot is shaped to guide the UAV tether from a wider opening into a narrower capture position. The shape and length of the slot is be dependent on the platform size and shape. For example, for round platforms, the slot may be a pie shaped slice with the apex of the pie shape stopping in the centre of the platform while for runway shaped platforms the slot may extend the entire length of platform to facilitate subsequent take offs from the platform. For example, for runway shaped platforms, the slot may extend across the entire platform and may be shaped such that it diverges to wider openings at both ends of the platform from a narrow centre point.

In certain embodiments, the arresting gear may be in the form of a capture means, such as electromechanical claws. For example, the arresting gear may comprise a set of automated claws that, after sensing the position of the tether, would grab it at any point on its way into the arresting slot and then pull it down and in to an ideal location for the refuelling or recharging connectors to be engaged. In certain embodiments, the capture means senses the tether as it enters the correct capture position, holds it, and pulls it down to the correct level for refuelling/recharging and to hold the UAV landing gear on the platform. In certain embodiments, the capture means pulls the landing gear of the UAV down firmly onto the platform to prevent damage from wind gusts during refuelling or recharging, and assist with the landing of the aircraft. Sensors which may be used with the arresting gear to detect that the tether is in place to be captured include but are not limited to simple electrical or mechanical pressure switches, infrared beams across the tether slot, or the pull on a wire or cable as the tether makes contact with it.

In other embodiments in which the tether has ends in a protuberance, such as a knob, a pair of sloped surfaces guides the tether to the optimal location at which point a capture means such as pincer claws, clamps, or magnets could latch on to hold it in place.

Optionally, the station includes one or more means which provide an indication that the station is available for use. In particular, a station may not be available for use due to a number of reasons including but not limited to; already in use by another UAV, or it is down for maintenance, or fuel cell/battery is depleted or is recharging. In certain embodiments, the station may send a communication, such as a radio communication, providing an indication of its availability. The communication may be sent automatically, for example continuously when available or on a cycle, or in response to a communication, for example autonomously from the UAV, or from a UAV pilot's command.

In certain embodiments which are for use with UAVs which have a camera, the indication may also be a visual indication, such as in the form of lights which provides an indication of availability.

Optionally, the station includes one or more landing aids. The landing aids may indicate the correct alignment. In the case of stations for use with UAVs which have a camera, the alignment aids could be in the form of visual cues, such as lights. Such lights may be on all the time or turned on either automatically or in response to a command from the UAV or station operator when a UAV is approaching. Other landing aids may include aids to assist the pilot with platform approach altitude such that the UAV approach is not too high for the arrest gear to make contact, or too low such that the UAV hits the edge of the platform. In the case of stations for use with UAVs which have a camera, the alignment aids could be in the form of visual cues, such as lights. For example, altitude aids may be similar to the “Ball” lighting system commonly used on aircraft carriers to help approaching aircraft come in at the right height above the deck. A worker skilled in the art would appreciate that the exact placement and angle of these lights would depend on the placement and angle of the UAV camera being used.

In certain embodiments, the landing aids include one or more types of platform lighting. The platform landing aid may include approach angle and orientation lighting which provides the operator camera feedback. In specific embodiments, the feedback is provided by coloured lighting. For example, green may indicate correct approach angle and direction; red may indicate too high and amber may indicate low. In addition, to the use of colours, flashes may be used to provide further information. For example, green flashes may indicate that the tether has been captured. The platform landing aid may include platform perimeter and centerline lighting. Appropriate types of lighting are known in the art and include but are not limited to LED.

The station further provides a refuelling and/or recharging function for the UAVs. Refuelling and recharging connectors for use in the invention are known in the art and are commercially available. A worker skilled in the art would readily appreciate that any arresting gear would have to be designed in such a way as not to impede the alignment and connection of these commercially available refuelling and recharging connectors.

The refuelling and/or recharging function may be a liquid fuel connection and/or electric connection. In embodiments where a liquid fuel connection is provided, the liquid fuel connection is a self-sealing system with fuel only able to flow once an airtight connection had been made. Fuel pumps would send a fixed amount of fuel to the tanks of the UAV and stop either when that limit had been reached, the UAV or UAV pilot indicated it had enough to continue and requested release, or backpressure from the pipeline indicated that the tank was full. In embodiments where electricity is provided, the connection must sense that the polarity of the connectors is correct, and that the voltage of the arriving UAV is compatible with the voltage available.

In embodiments where electrical recharging connections are provided, connections may include simple magnetic probes, spring-loaded clips, or pressure contact points that are held in place by the recharging/refuelling clamps. Recharging would continue until either the UAV, or the UAV's pilot, indicated he had enough to continue and requested release, or the current flow into the UAV batteries had dropped to indicate they were fully charged.

In some embodiments, the platform may be equipped for commercially available inductive charging or other non-contact charging systems for the UAV batteries. This would be no different in operation than the wired connections listed above.

In alternative embodiments, the station is configured for automated removal of the used batteries, fuel tanks, or fuel cells from the UAV. Once removed, fully charged batteries, filled tanks, or filled fuel cells would replace the ones that were removed to facilitate a rapid return to flight status for the UAV. In some embodiments, the station is configured to recharge or refill the removed batteries, fuel tanks, or fuel cells off-line in the station.

In certain embodiments, once the UAV is fully refuelled/recharged, the refuelling/recharging connection clamps are released, and then the tether arresting gear is released. At this point the UAV is free to carry on with its mission be either backing out of the platform slot on a dedicated VTOL UAV platform or flying straight forward on a Fixed Wing or Hybrid Fixed-wing/VTOL platform.

In some embodiments, the station is configured to automatically capture an UAV that lands on it and automatically establish the recharging or refuelling connections. As described above if the batteries are fully charged the platform will sense no current is flowing and would immediately disconnect. For liquid fuel UAVs the backflow pressure from the tanks would indicate that the tanks were full and the refuelling lines would immediately disconnect. Optionally the station could be configured to either autonomously release the UAV, or by remote command from an operator.

Alternatively, the UAV Recharging/Refuelling Stations can be provided with a radio command to retain the UAV on station for a period of time with the tether clamps engaged. This would allow the UAV to be located closer to areas of concern such as an oil spill or forest fire, in a fully charged condition, ready for rapid deployment when needed. For these situations, a retractable roof or canopy over the landing platform may be provided to protect the UAV from weather or other adverse conditions while it waits for deployment. This type of protective cover would also help keep the landing platform clear of snow, ice, or other materials that would make landings difficult. There are many such design options available that would work for such covers, but in all cases there are certain criteria that must be observed.

In certain embodiments for VTOL or Fixed-Wing UAV platform covers, the cover retracts in such a manner that, when open, it represents no physical restriction to the approaching or departing aircraft. Slight wind gusts during these manoeuvres could potentially push lightweight UAVs into the protruding parts of the cover and damage it. For these covers all components should optimally be positioned below the top plane of the landing platform.

In some embodiments for a variety of reasons, the platform cover could potentially be fixed in an arch-like shape over the platform and not be retractable. In these configurations the UAV would fly into the covered area above the platform, below the cover, and between the cover supports on the side, in order to land and be recharged or refuelled. These types of cover configurations would represent a potential flight hazard requiring extra skill from the pilots controlling the UAV, or for autonomous vehicles, much greater processing power, sensors, and rapid response times on the flight control surfaces.

For cover embodiments in areas where heavy snow loads, hail, or large volumes of rain, are possible, the covers should be sloped on the top to shed the any precipitation build-up off to the sides of the platform and reduce the load on motors trying to open the cover for approaching UAVs.

The recharging/refuelling station is equipped with a communication module that allows communication with an autonomous UAV, and/or a UAV controller/operator, and/or a central platform command, and/or other stations in the area. The communication module may be equipped to both send and receive communications and in some embodiments, will be configured to receive and send data and/or video optionally in real time or at set intervals. The communication module may be equipped with on-board storage.

In some embodiments, control signals from a remote system operator may be used to change or adjust operating parameters. For example, marking the station as off-line when it has run out of fuel or its own batteries are too low to recharge a UAV.

The communication module is optionally further configured to send station status updates to a central operator including if the station is on or off-line (for example, because of unanticipated malfunction), if the station is occupied, and optionally weather conditions at the station.

In some embodiments, the station will be configured to receive, optionally store, and transmit data and video from the UAV. Optionally, this data and video transfer from the UAV to the station is via radios once in range, or while the UAV is on the platform.

In some embodiments, stations communicate with a central control. Communications between stations and central control may be by direct wired communications lines, directly via long range two-way radios, or radios relaying back through adjacent stations, or directly via satellite radios on each station, directly via cellular modems on each station, or a suitable combination of each depending on local conditions and security requirements.

In certain embodiments, the station is configured to communicate with an approaching and/or tethered UAV. In some embodiments, communications with the approaching or tethered UAV would be via MESH enabled radio signals to permit any local area station to communicate with any valid UAV it has been configured to support.

Optionally, this communications link would be used to advise the UAV of platform readiness and for the exchange of guidance instructions for autonomous vehicles. For UAVs being controlled by an operator the Station communications system would also provide for the relay of Commands from the operator and Signals or Video Feeds back from the UAV.

In some embodiments, the station is optionally configured for direct connection of data interface cables between the UAV and the station. This hardwired data connection is accomplished in a manner similar to the electrical recharging connections.

In some embodiments, the station is configured for wireless download through a Bluetooth or Near-Field connection to make the file transfer during recharging or refuelling.

Depending on the type of radios used in the UAVs, the radios in the stations could also be used in a networked configuration to permit communication with the UAV, including with the onboard cameras, sensors, and other systems, at beyond line-of-sight distances. In certain embodiments, a series of stations communicate with each other and relay the control commands from the UAV pilot to a distant UAV and send the signals back to the operator over the same network.

Each station further includes a power module configured to power the operations of the station and recharge UAV batteries and/or run refuelling pumps. The station may be solar powered, wind turbine powered, local utility powered, or generator powered, or some optimal combination of each depending on local availability and site conditions. Optionally, the station may be provided with a battery backup or a fuel cell.

To use the station each UAV may be equipped with a tether. In some embodiments, the UAV comes equipped with an appropriate tether system. Alternatively, the appropriate tether is retrofitted onto the UAV. The tether may be of a standard size and is configured to interface with the arresting gear assembly of the station's landing platform, to hold the UAV in place on the platform, and to provide the link between the UAV and the recharging/refuelling components.

The UAV tether is a strong connection cable or post extending from the UAV's airframe down to a connection point for the landing platform. To facilitate capture by the arresting gear the tether may have a knob, ball or a hook at the end, and that may be weighted to help hold the tether at the right angle, typically vertical, during capture. The platform arresting gear captures the tether to pull down and hold the UAV in place during refuelling or recharging. The Tether may be hinged at the airframe end to allow it to fold back during normal flat surface landings and optionally may be retractable.

In combination with the tether extending down from the airframe to the arresting gear, there would be either the battery recharge leads for electric UAVs, or a flexible fuel line for liquid fuel powered vehicles. In some embodiments, these would terminate approximately 10 cm (4″) above the tether end to avoid interfering with, or damage from, the platform arresting gear.

In some embodiments, the tether includes battery recharge leads that optionally terminate in weather-protected connectors that would connect to the platform's recharging system battery terminals for quick charges.

The fuel line for liquid fuel UAVs would terminate in a self-sealing connector that would connect to the refuelling line from the platform fuel pump and be held in place by the arresting gear.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A recharging/refuelling station for an unmanned aerial vehicle (UAV) comprising a landing platform comprising a UAV capture system and a recharging or refuelling system.

2. The station according to claim 1, wherein the landing platform is elevated.

3. The station according to claim 2, wherein the landing platform is mounted on a pole or frame extending vertically from the ground.

4. The station according to claim 3, wherein the landing platform is rotatable or pivotably mounted on the pole or frame.

5. The station according to claim 4, wherein the landing platform comprises a weather vane and wherein the platform is optionally configured to pivot into the wind.

6. The station according to claim 1, wherein the UAV capture system comprises a tether guide and tether arresting gear.

7. The station according to claim 6, wherein the tether guide is a slot in the landing platform.

8. The station according to claim 1, comprising one or more station sensors or monitors.

9. The station according to claim 8, wherein the one or more stations sensors or monitors include power level sensors, tamper alarms, battery charge sensors, recharge voltage and current draw sensor, liquid fuel sensors, fuel pump sensors, fuel pressure and flow sensors, arresting gear monitors, wind speed and direction sensors, one or more cameras, GPS transponder, LIDAR approach guidance, radar situational awareness, platform position sensors, weather sensors, and communication status.

10. The station according to claim 1, comprising one or more solar panels.

11. The station according to claim 1, comprising a light to illuminate the landing platform

12. The station according to claim 1, comprising a communication module.

13. The station according to claim 12, wherein the communication module is configured to provide a beacon.

14. The station according to claim 13, wherein the beacon is a flashing light or radio beacon, or a GPS coordinates transmission.

15. The station according to claim 12, wherein the communication module is configured to provide a homing signal to UAVs to facilitate locating of the landing platform by a UAV.

16. The station according to claim 12, wherein the communication module comprises a GPS receiver.

17. The station according to claim 1, comprising a retractable or fixed roof or canopy.

18. The station according to claim 1, wherein the landing platform is configured for fixed-wing UAVs.

19. The station according to claim 1, wherein the landing platform is configured for VTOL UAVs.

20. A recharging/refuelling network for unmanned aerial vehicles (UAVs) comprising two or more stations of claim 1, wherein each station of the two or more stations is optionally in communication with at least one other station.

21. The recharging/refuelling network of claim 19, comprising a central command module configured to communicate with each station in the two or more stations and one or more UAVs.

22. The recharging/refuelling network of claim 21, wherein the central command module is configured to relay communication using two or more stations.

23. The recharging/refuelling network of claim 22, wherein the network is configured to increase the effective communication range between the central command and a UAV.

24. A tether for use with the station of claim 1.
